(19) United States
(12) Patent Application Publication
(10) Pub. No.: US 2017/0301239 A1
(43) Pub. Date: Oct. 19, 2017

(54) APPARATUS AND METHOD FOR GENERATING TRAVELING PATH OF AUTONOMOUS VEHICLE

(71) Applicant: Hyundai Motor Company, Seoul (KR)

(72) Inventors: Dong Hwi LEE, Suwon-si (KR); Keon Yup CHU, Suwon-si (KR); Hoi Won KIM, Gwacheon-si (KR); Su Jung YOO, Incheon (KR)

(73) Assignee: Hyundai Motor Company, Seoul (KR)

(21) Appl. No.: 15/231,516

(22) Filed: Aug. 8, 2016

(30) Foreign Application Priority Data
Apr. 15, 2016 (KR) 10-2016-0046370

(51) Int. Cl. G08G 1/16; G05D 1/02; G05D 1/00

(52) U.S. Cl. CPC G08G 1/166; G08G 1/167; G05D 1/0257; G05D 1/0088; G05D 1/024; G05D 1/0248

(57) ABSTRACT

An apparatus a method for generating a traveling path of a vehicle, may include a sensor device mounted in the vehicle and detecting a surrounding environment of the vehicle; and a controller determining a traveling space in which the vehicle is traveled by considering the surrounding environment of the vehicle, and generating the traveling path within the determined traveling space.

### CROSS-REFERENCE TO RELATED APPLICATION

The present application is based on and claims the benefit of priority to Korean Patent Application No. 10-2016-0046370, filed on Apr. 15, 2016, the entire contents of which is incorporated herein for all purposes by this reference.

### BACKGROUND OF THE INVENTION

### Field of the Invention

The present invention relates to an apparatus and a method for generating a traveling path of an autonomous vehicle that search for a traveling space of the autonomous vehicle by considering a surrounding environment of the autonomous vehicle, and generate a traveling path of the autonomous vehicle within the searched traveling space.

### Description of Related Art

In general, an autonomous vehicle recognizes both lanes of a crossroad on which it is being traveled, and is driven on the center of both lanes which are recognized. Further, the autonomous vehicle generates a candidate path within the crossroad by considering vehicles or obstacles around the autonomous vehicle, and selects a local path within a range without departing from the lane (a boundary line of a traveling crossroad) in order to avoid a collision with the obstacle and secure safety, thereby performing a traveling deviated from the center of the crossroad.

Therefore, when the autonomous vehicle according to the related art is driven on a narrow crossroad or a sharp curved road, it may difficult to generate a path capable of avoiding the collision with the vehicles or the obstacles around the autonomous vehicle in the range without departing from the traveling crossroad.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus and a method for generating a traveling path of an autonomous vehicle that search for a traveling space of the autonomous vehicle by considering a surrounding environment of the autonomous vehicle, and generate a traveling path of the autonomous vehicle within the searched traveling space.

According to an exemplary embodiment of the present invention, an apparatus for generating a traveling path of an autonomous vehicle includes: a sensor device mounted in the vehicle and sensing a surrounding environment of the vehicle; and a processor determining a traveling space in which the vehicle is traveled by considering the surrounding environment of the vehicle, and generating a traveling path within the determined traveling space.

The sensor device may include a camera, a radar, and a laser scanner.

The processor may include: a surrounding environment recognizer recognizing the surrounding environment of the vehicle based on measurement data measured by the sensor device; and a path planner searching for an extra space of a road adjacent to a traveling crossroad of the vehicle based on surrounding environment information output from the surrounding environment recognizer to determine the traveling space and generating one or more candidate paths within the determined traveling space to select any one path as the traveling path.

The surrounding environment information may include a lane, a road boundary, and a shape, a size, a relative distance, and relative velocity of an obstacle.

The path planner may generate the candidate paths based on a global path.

The extra space may be a marginal strip or a shoulder.

The path planner may determine the traveling crossroad of the vehicle and the extra space as the traveling space.

According to another exemplary embodiment of the present invention, a method for generating a traveling path of an autonomous vehicle includes: recognizing a surrounding environment of the vehicle using a variety of sensors mounted in the vehicle; determining a traveling space in which the vehicle is traveled by considering the surrounding environment of the vehicle; generating one or more candidate paths within the traveling space; and selecting any one of one or more candidate paths as a traveling path.

In the recognizing of the surrounding environment of the vehicle, surrounding environment information of the vehicle may be generated based on measurement data measured by a camera, a laser scanner, and a radar.

The surrounding environment information may include a lane, a road boundary, and a shape, a size, a relative distance, and relative velocity of an obstacle.

The determining of the traveling space may include: searching for an extra space of a road adjacent to a traveling crossroad on which the vehicle is being traveled; and determining the traveling space by reflecting the searched extra space.

In the searching of the extra space, a marginal strip or a shoulder adjacent to the traveling crossroad may be searched as the extra space of the road.

In the determining of the traveling space, the traveling crossroad of the vehicle and the extra space may be determined as the traveling space.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block configuration diagram illustrating an apparatus for generating a traveling path of an autonomous vehicle according to an exemplary embodiment of the present invention.

FIG. 2A, FIG. 2B and FIG. 2C are diagrams illustrating a process of generating a traveling path according to the present invention.

FIG. 3 is a flow chart illustrating a method for generating a traveling path of an autonomous vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Throughout the present specification, since the terms “comprising”, “configuring”, “having”, and the like mean that the corresponding element may be embedded unless explicitly described to the contrary in the present specification, it means the inclusion of other elements rather than the exclusion of any other elements.

In addition, the terms “-er”, “-or”, “module”, and the like described in the present specification mean units for processing at least one function and operation, and can be implemented by hardware, software, or combinations thereof. In addition, articles such as “a”, “an”, “the”, and the like may be used to include both singular forms and plural forms unless the context clearly indicates otherwise, in the context describing the present invention.

Hereinafter, exemplary embodiments of the present invention will be described in detail with reference to the accompanying drawings.

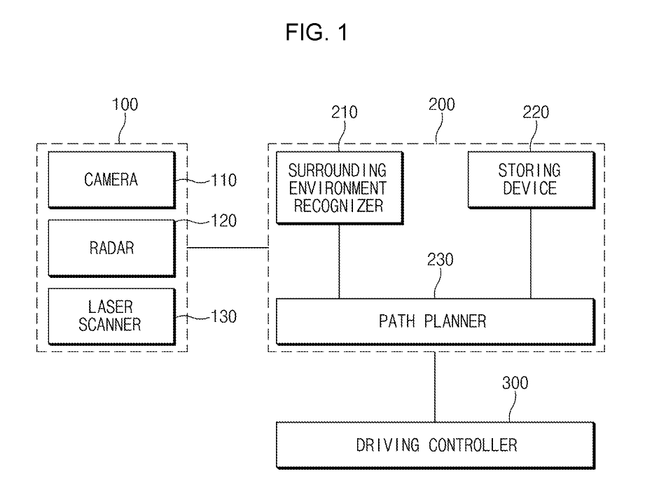

FIG. 1 is a block configuration diagram illustrating an apparatus for generating a traveling path according to an exemplary embodiment of the present invention.

As illustrated in FIG. 1, an apparatus for generating a traveling path of an autonomous vehicle includes a sensor device 100, a processor 200, and a driving controller 300.

The sensor device 100 senses a crossroad (a traveling crossroad) on which the vehicle is being driven, a road, obstacles (e.g., surrounding vehicles, a curb stone, a median strip, etc.), and the like using a variety of sensors mounted in the vehicle. The sensor device 100 includes a camera 110, a radar 120, a laser scanner 130, and the like.

The camera 110 is mounted in a front, a rear, and/or a side of the vehicle to obtain images around the vehicle. The camera 110 may be implemented by one or more wide angle cameras.

The radar 120 and the laser scanner 130 are mounted in a front, a rear, and/or a side of the vehicle to sense the obstacles around the vehicle. Here, the obstacles include the surrounding vehicles, the curb stone, the median strip, a guard rail, person, etc.

The processor 200 recognizes a surrounding environment of the vehicle using the sensor device 100, and generates a traveling path by considering the recognized surrounding environment. In this case, the traveling path means a local path.

The processor 200 includes a surrounding environment recognizer 210, a storing device 220, and a path planner 230.

The surrounding environment recognizer 210 recognizes the surrounding environment of the vehicle based on data measured by the sensor device 100. In other words, the surrounding environment recognizer 210 detects surrounding environment information of the vehicle based on the data measured by the sensor device 100. Here, the surrounding environment information includes information such as a lane, a road boundary, and a shape, a size, a relative distance, relative velocity, and a position of the obstacle, etc.

For example, the surrounding environment recognizer 210 may recognize the lane and the shape of the obstacle from the images obtained by the camera 110. In this case, the surrounding environment recognizer 210 may recognize the lane of the road using a known lane recognition technology applied to a lane keeping assist system (LKAS) using the camera 110.

In addition, the surrounding environment recognizer 210 detects the boundary line of the road by recognizing the curb stone, the median strip, the guard rail, or the like, and recognizes the shape, the size, the relative distance, the relative velocity, and the position of the obstacle using the radar 120 and the laser scanner 130.

The storing device 220 stores road information, map information, a traveling path generation program, and input and/or output data of the apparatus for generating a traveling path for the autonomous driving of the vehicle. In addition, the storing unit 220 may store a program for controlling an operation of the processor 200.

The storing device 220 may be implemented as any one of storage media such as a flash memory, a hard disk, a secure digital (SD) card, a random access memory (RAM), a read only memory (ROM), and a web storage.

The path planner 230 searches for an extra space adjacent to the traveling crossroad of the vehicle based on the surrounding environment information of the vehicle recognized by the surrounding environment recognizer 210. In other words, in the case in which any one of both lanes of the traveling crossroad matches the boundary line of the road, the path planner 230 searches for a space from the boundary line of the road to the curb stone (the boundary line of the road) or the median strip as the extra space. The extra space includes a marginal strip and/or a shoulder.

The path planner 230 determines the traveling path and the searched extra space as a traveling space. Here, the traveling space means a space in which the vehicle may be driven.

The path planner 230 generates one or more candidate paths within the determined traveling space. In this case, the path planner 230 generates one or more candidate paths in which a collision with the obstacle may be avoided, based on a global path.

The path planner 230 generates the candidate paths using a technique of generating the traveling path using a three-dimensional curve in relation to the autonomous vehicle.

The path planner 230 selects any one of the generated candidate paths as the traveling path. In this case, the path planner 230 selects the traveling path by considering terrain information of the road (a curved road, a straight road, or the like), the position of the obstacle, and the like.

For example, when the vehicle is driven on the straight road on which there are no obstacles around the vehicle, the path planner 230 selects a candidate path allowing the vehicle to be driven on the center of the traveling crossroad among the generated candidate paths as an optimal traveling path.

Meanwhile, when the vehicle is driven on the curved road, the path planner 230 selects one of candidate paths deviated in the opposite direction of centrifugal force among the generated candidate paths as the traveling path.

Meanwhile, when there are the obstacles around the vehicle, the path planner 230 selects a candidate path in which possibility of the collision with the obstacle may be reduced, as the optimal traveling path.

The path planner 230 may interface with a navigation device to map the selected traveling path on map data, thereby outputting the mapped result to a display (not illustrated).

The driving controller 300 performs a control so that the vehicle is driven along the traveling path selected by the path planner 230. The driving controller 300 operates a power generator, a power train, a driving apparatus, a steering apparatus, a brake, a suspension system, and a transmission to control a driving of the vehicle.

As described above, according to an exemplary embodiment of the present invention, the traveling space is not limited to within the lane of the traveling crossroad as in the related art, but an expanded traveling space is searched by considering the surrounding environment, thereby making it possible to further secure possibility of collision avoidance with the obstacles around the vehicle.

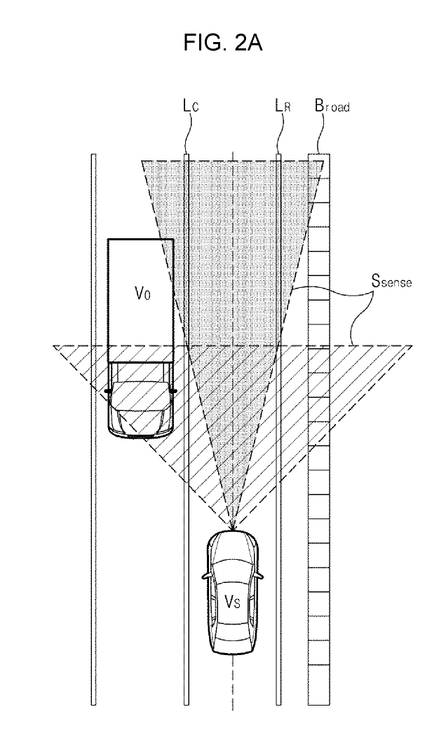

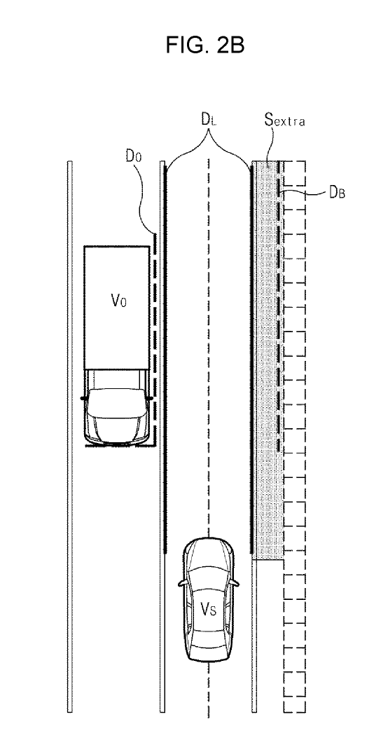

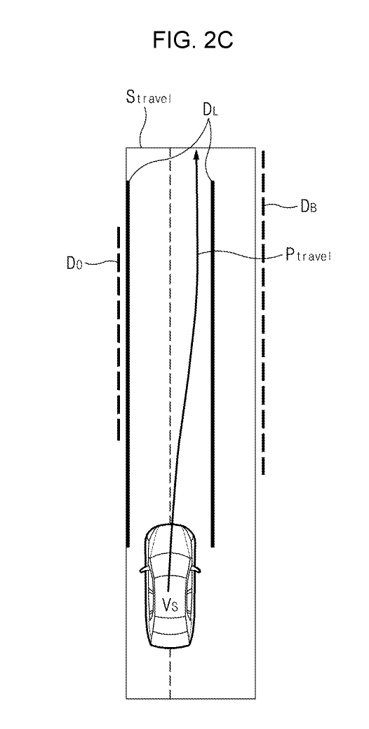

FIGS. 2A to 2C illustrate diagrams illustrating a process of generating a traveling path according to the present invention.

As illustrated in FIG. 2A, when a large vehicle Vₒ which is driven in the opposite direction of an autonomous vehicle Vₛ approaches the autonomous vehicle Vₛ while the autonomous vehicle Vₛ is driven on a two-lane road, an apparatus for generating a traveling path of the autonomous vehicle Vₛ senses the vehicle Vₒ positioned within a sensed space Sₛₑₙₛₑ, lanes L_{C} (traveling crossroad) and L_{R} (right lane), and a curb stone B_{road} installed at a crossroad boundary (a road boundary) using the sensor device 110.

The surrounding environment recognizer 210 of the apparatus for generating a traveling path obtains relative vehicle information D_{O}, lane information D_{L}, and crossroad boundary information D_{B} using the sensor device 110. That is, the surrounding environment recognizer 210 recognizes a shape, a size, relative velocity, and a relative distance of the relative vehicle Vₒ based on measurement data D_{O} for the relative vehicle Vₒ. The surrounding environment recognizer 210 recognizes a kind and position of lane from measurement data D_{L} for the lane. Further, the surrounding environment recognizer 210 recognizes a crossroad boundary line based on measurement data D_{B} for the crossroad boundary.

The path planner 230 searches for an extra space Sₑₓₜᵣₐ of a road adjacent to a traveling crossroad of the autonomous vehicle Vₛ based on the recognized surrounding environment information (see FIG. 2B). That is, the path planner 230 searches for a space between a right lane L_{R} of the traveling crossroad and the crossroad boundary line D_{B} as the extra space Sₑₓₜᵣₐ of the road.

The path planner 230 determines the extra space Sₑₓₜᵣₐ and the traveling crossroad of the autonomous vehicle Vₛ searched as illustrated in FIG. 2C as the traveling space Sₜᵣₐᵥₑₗ. The path planner 230 generates one or more candidate paths within the determined traveling space, and selects an optimal path among the generated candidate paths as a traveling path Pₜᵣₐᵥₑₗ.

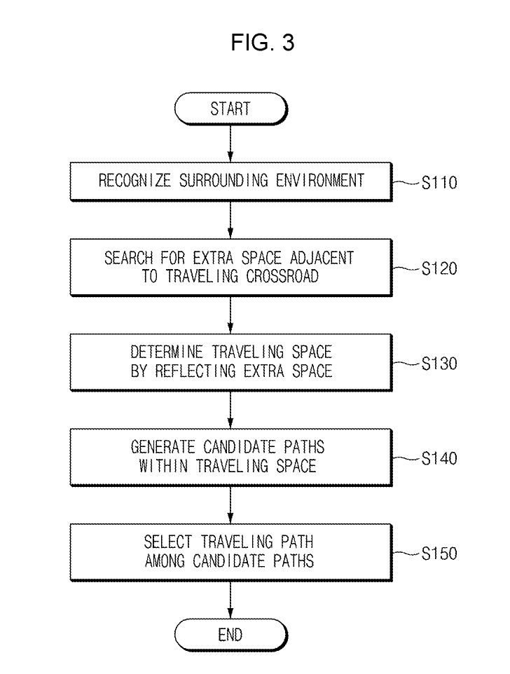

FIG. 3 is a flow chart illustrating a method for generating a traveling path of an autonomous vehicle according to an exemplary embodiment of the present invention.

As illustrated in FIG. 3, the processor 200 of the apparatus for generating a traveling path of an autonomous vehicle recognizes a surrounding environment of the vehicle using the sensor device 100 (S110). In this case, the surrounding environment recognizer 210 of the processor 200 detects (generates) surrounding environment information of the vehicle based on data measured by the sensor device 100. Here, the surrounding environment information includes information such as a lane, a road boundary, and a shape, a size, a relative distance, relative velocity, and a position of an obstacle, etc.

The processor 200 searches for an extra space of a road adjacent to a traveling crossroad of the vehicle (S120). The path planner 230 searches for a marginal strip, a safe zone, a shoulder, or the like adjacent to the traveling crossroad as the extra space of the road based on the surrounding environment information output from the surrounding environment recognizer 210.

The processor 200 determines a traveling space in which the vehicle may be traveled by reflecting the searched extra space (S130). In other words, the path planner 230 of the processor 200 determines the searched extra space and the traveling crossroad as the traveling space. As such, since the apparatus for generating a traveling path expands the extra space of the road adjacent to the traveling crossroad to the traveling space, it is possible to secure a wider traveling space.

The processor 200 generates one or more candidate paths within the determined traveling space (S140). In this case, the path planner 230 generates the candidate paths based on a global path.

The processor 200 selects any one of the generated candidate paths as the traveling path (S150). The path planner 230 selects a path having the highest safety among candidate paths as the traveling path. For example, when there is an obstacle around the vehicle, the path planner 230 selects a candidate path having the lowest possibility of the collision with the obstacle, as the traveling path.

Thereafter, the processor 200 transmits the selected traveling path to the driving controller 300. The driving controller 300 controls a driving of the vehicle along the traveling path. The processor 200 may map the selected traveling path on map data, thereby outputting the mapped result to a display.

As described above, according to the present invention, since the traveling space is determined using the extra space of the road such as the shoulder adjacent to the traveling crossroad by considering the surrounding environment of the autonomous vehicle, thereby making it possible to generate and provide a safe traveling path.

Although it has been mentioned that all components configuring the exemplary embodiment of the present invention described above are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent hardware, some or all of the respective components which are selectively combined with each other may also be implemented by a computer program having a program module performing some or all of functions combined with each other in one or plural hardwares. Codes and code segments configuring the computer program may be easily deduced by those skilled in the art. The computer program as described above may be stored in computer readable media, and be read and executed by a computer to implement the exemplary embodiments of the present invention.

As described above, according to the exemplary embodiments of the present invention, since the traveling space in which the autonomous vehicle may be driven is not limited to within the traveling crossroad, and the traveling space is expanded by searching for the extra space of the road adjacent to the traveling crossroad by considering the surrounding environment of the autonomous vehicle, safety of the autonomous driving may be improved.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for generating a traveling path of a vehicle, the apparatus comprising:
a sensor device mounted in the vehicle and detecting a surrounding environment of the vehicle; and
a controller determining a traveling space in which the vehicle is traveled by considering the surrounding environment of the vehicle, and generating the traveling path within the determined traveling space.

2. The apparatus according to claim 1, wherein the sensor device includes a camera, a radar, and a laser scanner.

3. The apparatus according to claim 1, wherein the controller includes:
a surrounding environment recognizer recognizing the surrounding environment of the vehicle on a road based on data detected by the sensor device; and
a path planner searching for an extra space of the road adjacent to a traveling crossroad of the vehicle based on surrounding environment information output from the surrounding environment recognizer, determining the traveling space, and generating at least one candidate path within the determined traveling space to select one path of the at least one candidate path as the traveling path.

4. The apparatus according to claim 3, wherein the surrounding environment information includes a lane and a road boundary of the road, and a shape, a size, a relative distance, and relative velocity of an obstacle.

5. The apparatus according to claim 3, wherein the path planner generates the at least one candidate path based on a global path.

6. The apparatus according to claim 3, wherein the extra space is a marginal strip or a shoulder of the road.

7. The apparatus according to claim 3, wherein the path planner determines the traveling space based on the traveling crossroad of the vehicle and the extra space.

8. The apparatus according to claim 7, wherein the extra space is a space formed between a lane and a road boundary of the road, the line disposed opposite to the traveling crossroad.

9. A method for generating a traveling path of a vehicle, the method comprising:
recognizing, by a controller, surrounding environment of the vehicle using at least one sensor device mounted in the vehicle;
determining, by the controller, a traveling space in which the vehicle is traveled by considering the surrounding environment of the vehicle;
generating, by the controller, at least one candidate path within the traveling space; and
selecting, by the controller, one path of the at least one candidate path as the traveling path.

10. The method according to claim 9, wherein in the recognizing of the surrounding environment of the vehicle, surrounding environment information of the vehicle is generated based on data detected by the at least one sensor device including a camera, a laser scanner, and a radar.

11. The method according to claim 10, wherein the surrounding environment information includes a lane and a road boundary of a road, and a shape, a size, a relative distance, and relative velocity of an obstacle.

12. The method according to claim 9, wherein the determining of the traveling space includes:
searching for an extra space of a road, wherein the extra space is adjacent to a traveling crossroad of the road on which the vehicle is being traveled; and
determining the traveling space by reflecting the searched extra space.

13. The method according to claim 12, wherein in the searching of the extra space, a marginal strip or a shoulder adjacent to the traveling crossroad is searched as the extra space of the road.

14. The method according to claim 12, wherein in the searching of the extra space, the extra space is a space formed between a lane and a road boundary of the road, the line disposed opposite to the traveling crossroad.

15. The method according to claim 12, wherein in the determining of the traveling space, the traveling crossroad of the vehicle and the extra space are determined as the traveling space.

16. The method according to claim 12, wherein the controller includes:
a surrounding environment recognizer recognizing the surrounding environment of the vehicle on the road based on data detected by the at least one sensor device; and
a path planner searching for the extra space of the road adjacent to the traveling crossroad of the vehicle based on surrounding environment information output from the surrounding environment recognizer, determining the traveling space, and generating the at least one candidate path within the determined traveling space to select the one path of the at least one candidate path as the traveling path.
